(19) United States
(12) Patent Application Publication
(10) Pub. No.: US 2023/0329147 A1
(43) Pub. Date: Oct. 19, 2023

(54) GROUNDS MAINTENANCE VEHICLE WITH COVER RETENTION SYSTEM

(71) Applicant: EXMARK MANUFACTURING COMPANY INCORPORATED, Beatrice, NE (US)

(72) Inventors: Robert Allen Ostdiek, Beatrice, NE (US); Elisha Christian Bair, Beatrice, NE (US); Joseph J. Oliver, Lincoln, NE (US)

(21) Appl. No.: 18/128,065

(22) Filed: Mar. 29, 2023

Related U.S. Application Data
(60) Provisional application No. 63/330,975, filed on Apr. 14, 2022.

(51) Int. Cl. A01D 34/81; A01D 34/69

(52) U.S. Cl. CPC A01D 34/81; A01D 34/69; A01D 2101/00

(57) ABSTRACT

A grounds maintenance vehicle including a cover positioned over at least a portion a frame of the vehicle and a method of attaching the cover to the portion of the frame. The cover defines an inner surface, an outer surface opposite the inner surface, and an opening extending between the inner and outer surfaces. The vehicle also includes a retention apparatus operably coupled to the frame and corresponding to the opening. The retention apparatus includes a head portion and a biasing member. The biasing member is configured to be biased towards the head portion. The retention apparatus extends through the opening such that the head portion and the biasing member apply force to each of the opposite surfaces to restrict movement of the cover relative to the frame.

The present application claims priority to and/or the benefit of U.S. Provisional Patent Application No. 63/330,975, filed Apr. 14, 2022, which is incorporated herein by reference in its entirety.

Embodiments of the present disclosure are directed to grounds maintenance vehicles such as ride-on and walk-behind lawn mowers and, more particularly, to such vehicles incorporating a cover retention system.

### BACKGROUND

Grounds maintenance vehicles such as lawn mowers and the like are used by homeowners and professionals alike to care for turf and other ground surfaces. These vehicles typically include a prime mover, e.g., internal combustion engine or electric motor, to power not only an implement (e.g., cutting deck) attached to the vehicle, but also a traction drive system, the latter adapted to propel the vehicle over a ground surface.

Generally speaking, mowers and other grounds maintenance vehicles are configured as either ride-on or walk-behind machines. Moreover, ride-on vehicles may be adapted to support either a sitting (“sit-on”) or standing (“stand-on”) operator.

Grounds maintenance vehicles often include a cover or shield positioned over a portion of the frame. For example, the cover may be positioned over at least a portion of the implement to protect and conceal components located under the cover (e.g., belts, pulleys, motors, etc. that may or may not be associated with the implement). The cover may be coupled to the frame in a variety of different ways using one or more of various different types of fasteners. As such, the cover may not be easily removable or movable to a position that permits access to the components under the cover. For example, the fasteners used to couple the cover to the frame may require tools to couple or uncouple.

### SUMMARY

Embodiments described herein may provide a grounds maintenance vehicle including a frame carrying a prime mover and extending along a longitudinal axis between a front end and a rear end. The vehicle may also include ground engaging members operatively attached to the frame. At least one of the ground engaging members may be powered by the prime mover to propel the frame over a ground surface. Further, the vehicle may include an implement attached to the frame and a cover positioned over at least a portion of the implement. The cover may define an inner surface, an outer surface opposite the inner surface, and an opening extending between the inner and outer surfaces. The vehicle may also include a retention apparatus operably coupled to the frame and corresponding to the opening. The retention apparatus may include a head portion and a biasing member. The biasing member may be configured to be biased towards the head portion. The retention apparatus may extend through the opening such that the head portion and the biasing member apply force to each of the opposite surfaces to restrict movement of the cover relative to the frame.

Other embodiments described herein may provide a grounds maintenance vehicle including a frame carrying a prime mover and extending along a longitudinal axis between a front end and a rear end. The vehicle may also include ground engaging members operatively attached to the frame. At least one of the ground engaging members may be powered by the prime mover to propel the frame over a ground surface. Further, the vehicle may include a cover positioned over at least a portion of the frame. The cover may define an inner surface, an outer surface opposite the inner surface, and a keyhole opening. The keyhole opening may define a head opening and a slot opening extending from the head opening. The vehicle may include a retention apparatus operably coupled to the frame and corresponding to the keyhole opening. The retention apparatus may include an elongated member and a cap. The elongated member may include a head portion and a shank extending from the head portion. The cap may be configured to move relative to the elongated member along the shank. The head opening of the keyhole opening may be configured to permit passage of the head portion therethrough and deny passage of the cap. The slot opening of the keyhole opening may be configured to deny passage of both the head portion and the cap.

Yet other embodiments described herein may provide a lawnmower including a frame carrying a prime mover and extending along a longitudinal axis between a front end and a rear end. The vehicle also may include ground engaging members operatively attached to the frame. At least one of the ground engaging members may be powered by the prime mover to propel the frame over a ground surface. Further, the vehicle may include an implement attached to the frame and a cover positioned over at least a portion of the implement. The cover may define an inner surface, an outer surface opposite the inner surface, and a keyhole opening. The keyhole opening may define a head opening and a slot opening extending from the head opening. The vehicle may include a retention apparatus operably coupled to the frame and corresponding to the keyhole opening. The retention apparatus may include an elongated member having a head portion and a shank extending from the head portion. The head opening of the keyhole opening may be configured to permit passage of the head portion therethrough and the slot opening of the keyhole opening may be configured to deny passage of the head portion. The retention apparatus may also include a cap defining an opening through which the shank of the elongated member is positioned such that the cap is configured to move relative to the elongated member along the shank. The head opening of the keyhole opening may be configured to deny passage of the cap and the slot opening of the keyhole opening may be configured to deny passage of the cap. Further, the retention apparatus may include a spring operably connected to the cap to bias the cap towards the head portion. The retention apparatus may extend through the keyhole opening such that the cap is configured to apply force to the inner surface of the cover proximate the slot opening and the head portion may be configured to apply force to the outer surface of the cover proximate the slot opening to restrict movement of the cover relative to the frame.

Yet other embodiments described herein may provide a method of securing a cover to a frame of a grounds maintenance vehicle. The method may include positioning the cover relative to the frame. The frame may carry a prime mover and may extend along a longitudinal axis between a front end and a rear end. Ground engaging members may be operatively attached to the frame and at least one of the ground engaging members may be powered by the prime mover to propel the frame over a ground surface. The cover may define an inner surface, an outer surface opposite the inner surface, and a keyhole opening. The keyhole opening may define a head opening and a slot opening extending from the head opening. The method may also include inserting a head portion of a retention apparatus through the head opening of the keyhole opening. The retention apparatus may include an elongated member having the head portion and a shank extending from the head portion. The retention apparatus may also include a cap configured to be biased towards the head portion and to move relative to the elongated member along the shank. Further, the method may include applying force to the cover to move the cap against the biasing force. The cap may contact the cover and may be prevented from passing through the head opening. The method may also include moving the cover to position shank within the slot opening of the keyhole opening and releasing the force applied to the cover such that cap and head portion come into contact with the opposite surfaces of the cover proximate the slot opening.

The above summary is not intended to describe each embodiment or every implementation. Rather, a more complete understanding of various illustrative embodiments will become apparent and appreciated by reference to the following Detailed Description of Exemplary Embodiments in view of the accompanying figures of the drawing.

### BRIEF DESCRIPTION OF THE VIEWS OF THE DRAWING

Exemplary embodiments will be further described with reference to the figures of the drawing, wherein:

FIG. 1A is a left front perspective view of a grounds maintenance vehicle including a cover attached to a frame of the vehicle through an illustrative retention system in accordance with embodiments of the present disclosure;

FIG. 1B is an expanded view of the vehicle of FIG. 1A;

FIG. 2 is a left front perspective view of the vehicle of FIG. 1A with the cover removed;

FIG. 3 is an isolated perspective view of components of a retention system in accordance with embodiments of the present disclosure;

FIG. 4A is a perspective view of an opening of the cover of FIG. 1A;

FIG. 4B is a top plan view of the opening of FIG. 4A;

FIG. 5 is a cross-sectional view of the cover of the vehicle of FIG. 1A positioned relative to components of the retention system;

FIG. 6 is a cross-sectional view of the cover of the vehicle of FIG. 1A illustrating components of the retention system passing through an opening of the cover;

FIG. 7 is a cross-sectional view of the cover of the vehicle of FIG. 1A secured to the frame using the retention system;

FIG. 8 is an expanded perspective view of the cover and the retention system of FIG. 7;

FIG. 9 is a flow diagram that illustrates one example of a method for securing a cover to a frame of a grounds maintenance vehicle in accordance with embodiments of the present disclosure;

FIG. 10A is a left front perspective view a cover attached to a portion of a frame of a grounds maintenance vehicle through an illustrative retention system in accordance with another embodiment of the present disclosure;

FIG. 10B is an isolated view of an elongated member of the retention system of FIG. 10A;

FIG. 10C is an isolated view of the cover of FIG. 10A;

FIG. 10D is an isolated view of the portion of the frame of the vehicle of FIG. 10A;

FIG. 11 is a perspective view of another embodiment of the retention system of FIG. 10A;

FIG. 12A is a left front perspective view a cover attached to a portion of a frame of a grounds maintenance vehicle through an illustrative retention system in accordance with yet another embodiment of the present disclosure;

FIG. 12B is an isolated view of the portion of the frame of the vehicle of FIG. 12A;

FIG. 12C is an isolated view of the cover of FIG. 12A;

FIG. 12D is an expanded view of the retention system of FIG. 12A;

FIG. 13 is a perspective view of another embodiment of the retention system of FIG. 12A;

FIG. 14A is a left front perspective view a cover attached to a portion of a frame of a grounds maintenance vehicle through an illustrative retention system in accordance with yet another embodiment of the present disclosure;

FIG. 14B is an isolated view of the portion of the frame of the vehicle of FIG. 14A;

FIG. 14C is an isolated view of the cover of FIG. 14A;

FIG. 14D is an expanded view of the cover of FIG. 14C;

FIG. 15A is a left front perspective view a cover that is configured to be attached to a portion of a frame of a grounds maintenance vehicle through an illustrative retention system in accordance with yet another embodiment of the present disclosure;

FIG. 15B is an expanded view of the portion of the frame of the vehicle of FIG. 15A;

FIG. 15C is an expanded view of the retention system of FIG. 15A attaching the cover to the vehicle;

FIG. 16A is a left front perspective view a cover attached to a portion of a frame of a grounds maintenance vehicle through an illustrative retention system in accordance with yet another embodiment of the present disclosure;

FIG. 16B is an isolated view of the cover of FIG. 16A;

FIG. 16C is an expanded view of the retention system and the portion of the frame of the vehicle of FIG. 16A; and

FIG. 16D is a cross-sectional view of the illustrative retention system of FIG. 16A.

The figures are rendered primarily for clarity and, as a result, are not necessarily drawn to scale. Moreover, various structure/components, including but not limited to fasteners, electrical components (wiring, cables, etc.), and the like, may be shown diagrammatically or removed from some or all of the views to better illustrate aspects of the depicted embodiments, or where inclusion of such structure/components is not necessary to an understanding of the various exemplary embodiments described. The lack of illustration/description of such structure/components in a particular figure is, however, not to be interpreted as limiting the various embodiments in any way.

### DETAILED DESCRIPTION OF ILLUSTRATIVE EMBODIMENTS

In the following detailed description of illustrative embodiments, reference is made to the accompanying figures of the drawing which form a part hereof. It is to be understood that other embodiments, which may not be described and/or illustrated herein, are certainly contemplated.

All headings provided herein are for the convenience of the reader and should not be used to limit the meaning of any text that follows the heading, unless so specified. Moreover, unless otherwise indicated, all numbers expressing quantities, and all terms expressing direction/orientation (e.g., vertical, horizontal, parallel, perpendicular, etc.) in the specification and claims are to be understood as being modified by the term “about.” The term “and/or” (if used) means one or all of the listed elements or a combination of any two or more of the listed elements. “I.e.” is used as an abbreviation for the Latin phrase id est, and means “that is.” “E.g.,” is used as an abbreviation for the Latin phrase exempli gratia, and means “for example.”

Embodiments of the present disclosure are directed to powered (e.g., self-propelled) grounds maintenance vehicles incorporating a cover removably attachable to a frame of the vehicle (e.g., to access components under the cover) using a retention system as described herein. The embodiments of the present disclosure may include one or more retention apparatus fixedly coupled to the frame (and/or the cover) and configured to interact with the cover to removably couple and secure the cover to the frame. For example, the cover may include openings that correspond to each of the one or more retention apparatus such that the retention apparatus interacts with the opening of the cover to removably secure the cover to the frame. Specifically, the retention apparatus may be engaged with the associated opening of the cover to restrict movement of the cover relative to the frame and the retention apparatus may be disengaged with the associated opening of the cover to allow the cover to be removed from the frame.

In one or more embodiments, the retention apparatus may include components that are oriented in a specific way relative to the cover to prevent movement of the cover and secure the cover in place. For example, the retention apparatus may include an elongated member (e.g., a fastener, a bolt, a pin, a rod, a shaft, etc.) and a cap that moves relative to the elongated member to clamp the cover between a portion of the elongated member and the cap. Further, the cover may define an opening such that at least a portion of the elongated member (e.g., a head portion) may pass through the opening to the other side of the cover and the cap is restricted from passing through the opening. Therefore, the portion of the elongated member (e.g., the head portion) may be positioned on one side of the cover and the cap may be positioned on the other side of the cover. Additionally, the cap may be biased towards the head portion (e.g., using a biasing member) such that the head portion and the cap may apply a clamping force to the cover.

Furthermore, the opening of the cover may define a specific shape to allow and restrict different components of the retention apparatus passing through the opening. For example, the opening may include a first opening configured (e.g., sized) to allow the head portion to pass therethrough and to prevent the cap from passing therethrough. The opening may also include a second opening connected to the first opening and configured (e.g., sized) to prevent both the head portion and the cap from passing through the second opening. As such, the head portion may pass through the first opening (e.g., while restricting the cap) and the retention apparatus may be moved to be within the second opening (e.g., because a shank of the elongated member may be permitted within the second opening) such that neither of the head portion nor the cap may pass through the cover (e.g., through the second opening). Specifically, the opening may define a keyhole shape that may include a head opening (e.g., the first opening) and a slot opening (e.g., the second opening) extending from the head opening.

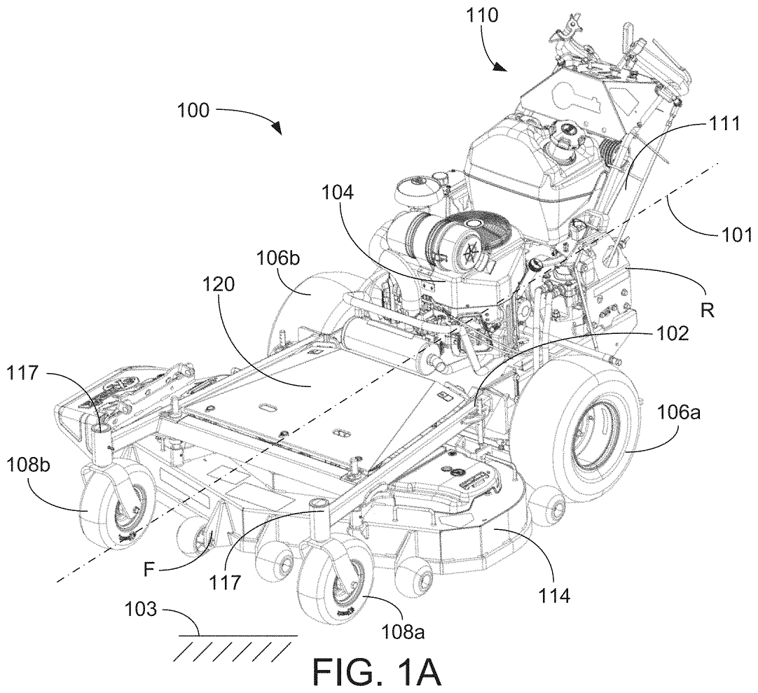

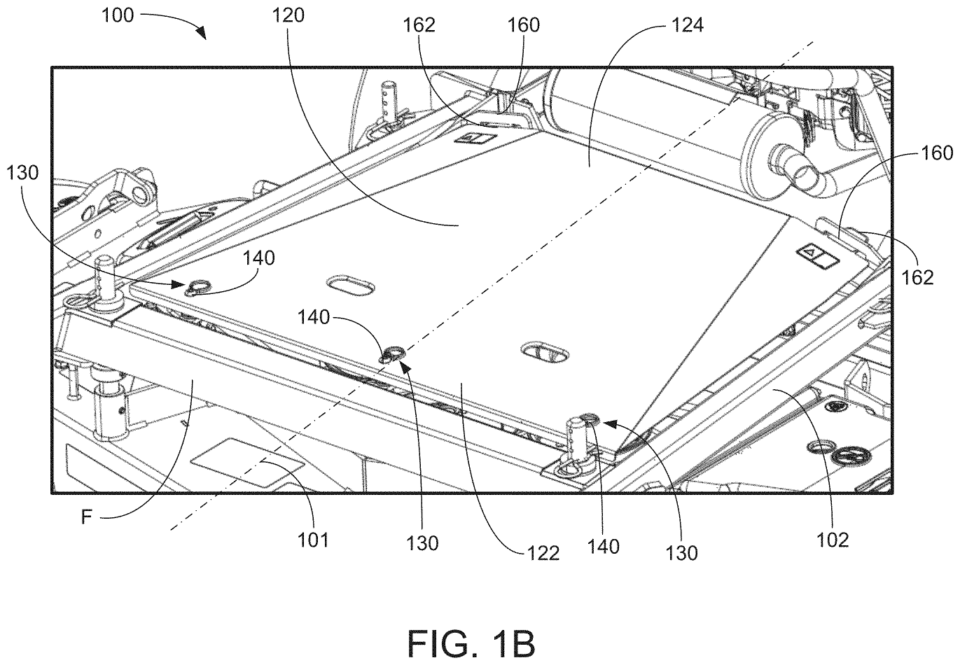

With reference to the figures of the drawing, wherein like reference numerals designate like parts and assemblies throughout the several views, FIGS. 1-16 illustrate a retention system, in accordance with one embodiment of the present disclosure, for removably coupling and securing a cover 120 to a chassis 102 (e.g., a frame) of a grounds maintenance vehicle 100.

While, for the sake of brevity, embodiments of the disclosure are herein described with reference to a lawn mower, those of skill in the art will realize that the concepts described herein are equally applicable to other types of grounds maintenance vehicles. Such vehicles may include, for example, skid-steer loaders, aerators, material spreaders and sprayers, snow throwers, tillers, etc.

It is noted that the terms “including,” “having,” “comprises” and variations thereof do not have a limiting meaning where these terms appear in the accompanying description and claims. Further, “a,” “an,” “the,” “at least one,” and “one or more” are used interchangeably herein. Moreover, relative terms such as “left,” “right,” “front,” “fore,” “forward,” “rear,” “aft,” “rearward,” “top,” “bottom,” “side,” “upper,” “lower,” “above,” “below,” “horizontal,” “vertical,” and the like may be used herein and, if so, are from the perspective of one operating the vehicle 100 while the vehicle 100 is in an operating configuration, e.g., while the vehicle 100 is positioned such that ground-engaging members (e.g., wheels 106 and 108) rest upon a generally horizontal ground surface 103 as shown in FIG. 1A. These terms are used only to simplify the description, however, and not to limit the interpretation of any embodiment described.

Still further, the suffixes “a” and “b” may be used throughout this description to denote various left- and right-side parts/features, respectively. However, in most pertinent respects, the parts/features denoted with “a” and “b” suffixes are substantially identical to, or mirror images of, one another. It is understood that, unless otherwise noted, the description of an individual part/feature (e.g., part/feature identified with an “a” suffix) also applies to the opposing part/feature (e.g., part/feature identified with a “b” suffix). Similarly, the description of a part/feature identified with no suffix may apply, unless noted otherwise, to both the corresponding left and right part/feature.

While not necessarily central to an understanding of exemplary embodiments of the present disclosure (e.g., other mower and other vehicle configurations are certainly contemplated), the general construction of the illustrative mower 100 is briefly described below. FIG. 1A illustrates the mower 100 including a frame or chassis 102 having a front end F and a rear end R (and a longitudinal axis 101 extending between the front and rear ends), the chassis 102 supporting a power source or prime mover, e.g., internal combustion engine 104. A pair of transversely opposing, ground-members, e.g., first and second (left and right) rear drive wheels 106a and 106b, may be coupled to opposite (left and right) rear sides of the chassis to support the mower upon, and propel the mower 100 relative to, the ground surface 103. Each drive wheel 106 may be powered by its own hydraulic motor that receives power from, at least in one embodiment, its own hydrostatic pump. Other drive systems, e.g., gear or pulley driven systems, may also be utilized by the mower 100.

Operator controls, as further described below, permit independent control of the speed and direction of each drive wheel 106, allowing operator control of mower 100 speed and direction. The operator may control the mower from a sitting position or from a walking or riding (e.g., standing) position generally behind the mower 100. A pair of front ground-engaging members (e.g., left and right caster wheels 108a, 108b), which may be connected to forwardly extending frame rails 117 (of the chassis 102), may support the front of the mower 100 in rolling engagement with the ground surface 103.

Although the illustrated mower 100 has the drive wheels 106 in the rear and caster wheels 108 in front, this configuration is not limiting. For example, other embodiments may reverse the location of the wheels, e.g., drive wheels in front and driven or undriven wheels in back. Moreover, other configurations may use different wheel configurations altogether, e.g., a tri-wheel configuration or a vehicle having conventionally-steered wheels. These and other embodiments are certainly possible without departing from the scope of the present disclosure. Moreover, while illustrated herein as wheels, other ground-engaging members (e.g., tracks, skids, etc.) are also contemplated.

The mower 100 may further include an operator control system 110. In the illustrated embodiment, the control system 110 may include operator controls that are mounted to upwardly extending portions of the chassis referred to herein as a control tower 111. The control tower 111 may be located at or near the rear end R of the mower 100. Situated near the top of the control tower is a control area that positions mower controls within comfortable reach of an operator who may be standing either behind the mower or upon a platform. The control system 110 may include control levers configured to move the mower 100 forward and rearward. The control system 110 may also include a parking brake handle to selectively activate a brake when the vehicle is parked. A deck height adjustment lever may also be provided to adjust the cutting height of a cutting deck 114. Other controls may include a throttle lever to control the speed of the engine 104, and an implement clutch control to initiate and terminate power delivery to the cutting blades of the mower deck 114.

Further, the illustrative mower 100 may include an operator support configured to support an operator standing behind the mower 100 such that the operator is positioned relative to the control system 110 and moves along with the mower 100. The operator support may include a standing platform attached to the chassis 102 at or near the rear end R. The standing platform may be configured to support the standing operator. Specifically, the operator support (e.g., including the standing platform) may be located aft of the control tower 111.

An implement, e.g., cutting deck 114, may be connected to a lower side of the chassis 102 (generally longitudinally between the drive wheels 106 and the caster wheels 108). The cutting deck 114 may include one or more cutting blades as known in the art. The cutting blades may be operatively powered, via spindles connected to the deck, by the engine 104 via, e.g., an implement drive system or deck drive system. During operation, power may be selectively delivered to the cutting deck 114, whereby the blades rotate at a speed sufficient to sever grass and other vegetation as the cutting deck passes over the ground surface 103. As indicated above, other grounds maintenance vehicles may locate the implement at other locations, e.g., along the side of the chassis or forward of the chassis (e.g., a forwardly-mounted or “out-front” deck configuration). For example, as shown in FIG. 1A, the cutting deck 114 is positioned forward (e.g., along the longitudinal axis 101) of the control tower 111. Moreover, while described as a cutting deck, the implement may be any tool (e.g., aerator, etc.) that attaches to the chassis 102.

The mower 100 may further include a cover 120 extending over at least a portion of the chassis 102 (e.g., at any portion of the chassis 102). The cover 120 may be removably attachable to the chassis 102. In one or more embodiments, the cover 120 may extend over at least a portion of the implement deck 114. The cover 120 may be removably attached to the chassis 102 through a retention apparatus 140 and corresponding feature(s) (e.g., openings) positioned on the cover 120, as will be described further herein. The cover 120 may be removed to access components thereunder (e.g., belts, pulleys, motors, etc. that may or may not be associated with the implement deck 114). The components located at least partially under the cover 120 may include one or more drive train components located between the deck 114 and the cover 120 when the cover 120 is in an attached position. The one or more drive train components may include an exhaust system, implement drive, an engine, an electric storage device (e.g., a battery), etc. Further, when the cover 120 is in an attached or closed position, the cover 120 may be configured to isolate or protect the components positioned thereunder from the area surrounding the outside of the cover 120 (e.g., the external environment).

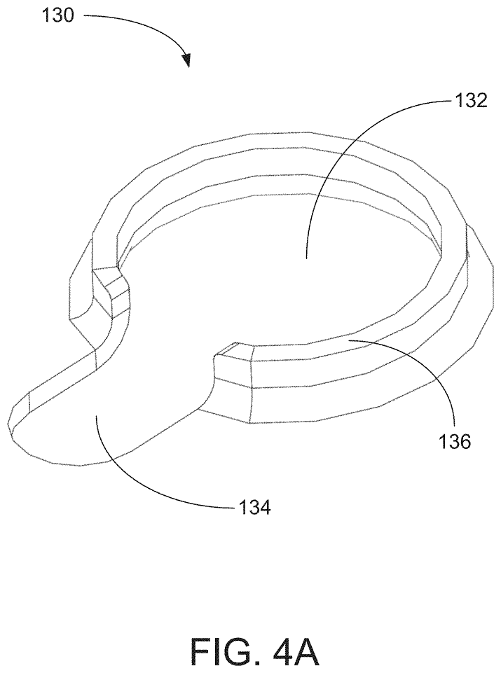

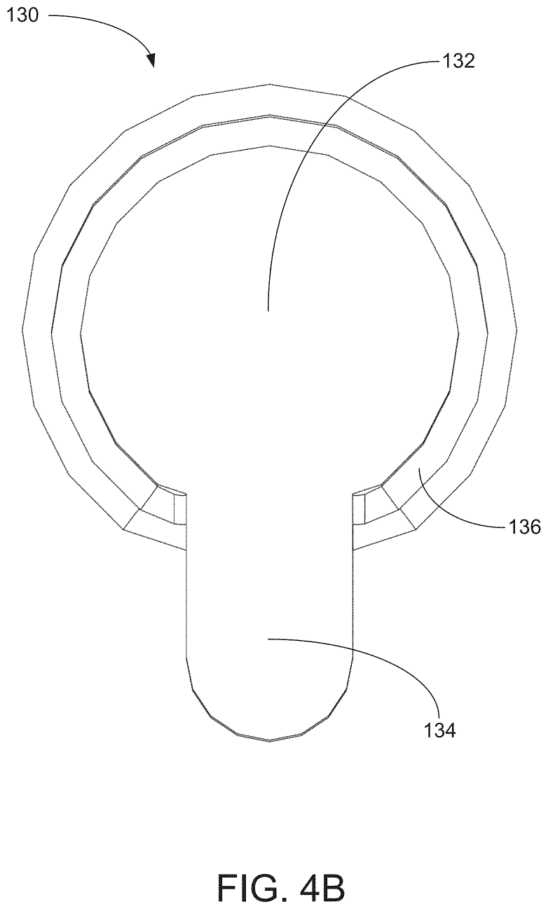

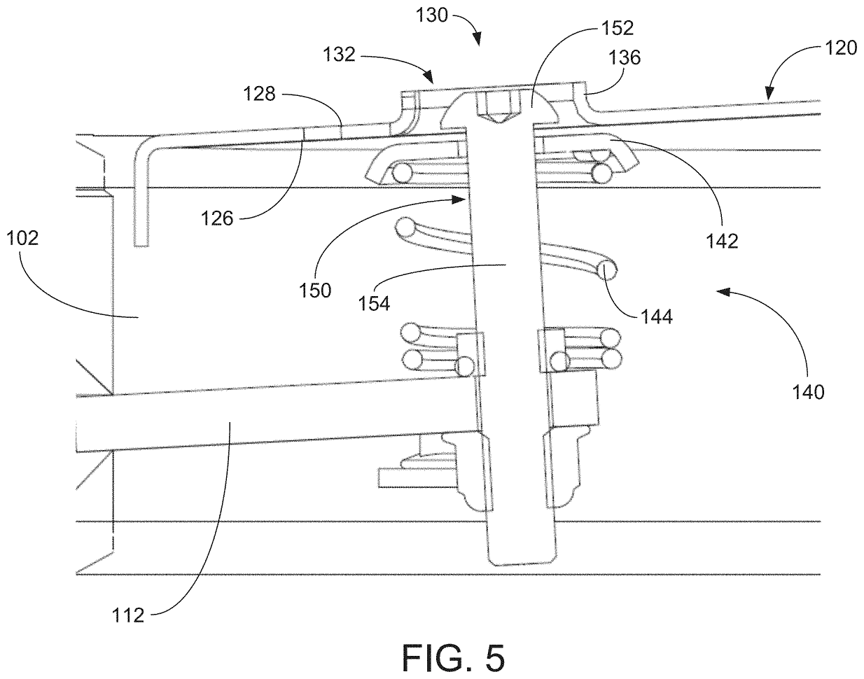

The cover 120 may extend between a first end region 122 (e.g., front end region) and a second end region 124 (e.g., rear end region), as shown in FIG. 1B. For example, the first end region 122 of the cover 120 may be proximate the front end F of the chassis 102 and the second end region 124 of the cover 120 may be rearward of the first end region 122. Further, the cover 120 may define an inner surface 126, an outer surface 128 (e.g., as shown in FIGS. 5-7) opposite the inner surface 126, and one or more openings 130 extending between the inner and outer surfaces 126, 128. The cover 120 may define an opening 130 (e.g., as shown in FIGS. 4A and 4B) to correspond to each of the retention apparatus 140 such that the retention apparatus may interact (e.g., engage and disengage) with the associated opening 130 (e.g., as shown in FIG. 1B) to removably secure the cover 120 relative to the chassis 102.

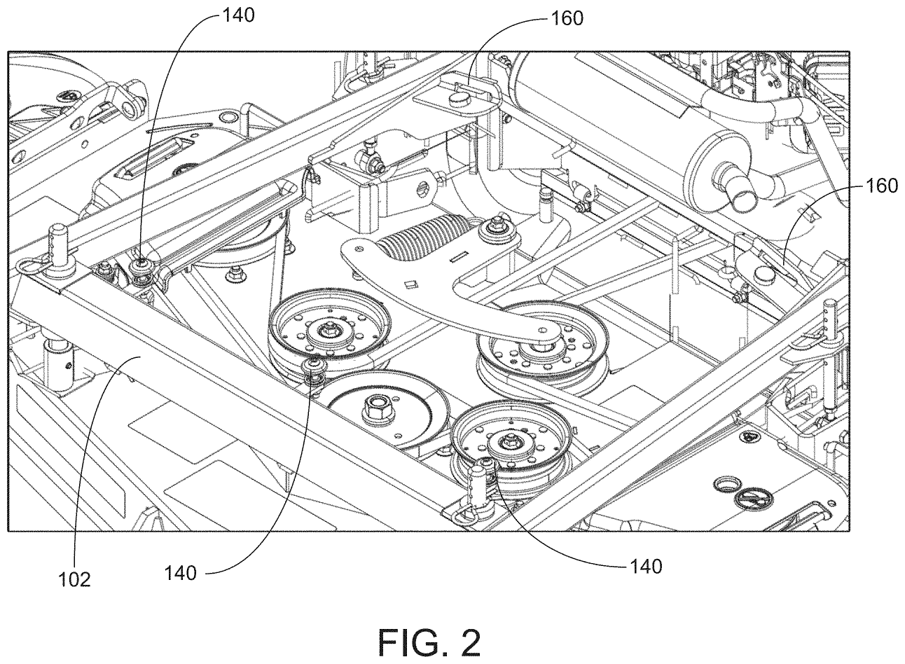

Also, in one or more embodiments, the cover 120 may be set into position using tabs 162 and slots 160, e.g., as shown in FIG. 1B. For example, the cover 120 may be generally located relative to the chassis 102 using the tabs 162 and slots 160 and then may be removably coupled to the chassis 102 using the retention apparatus 140. Specifically, the slots 160 (e.g., defined by either the cover 120 or the chassis 102) may be configured to receive the tabs 162 (e.g., defined by the other of the cover 120 or the chassis 102) to restrict movement of the cover in at least two orthogonal dimensions. In other words, the tabs 162 may be inserted into (and move relative to) the slots 160 along a first dimension (e.g., generally parallel to the longitudinal axis 101), but the tabs 162 may be restricted from translating in a direction perpendicular to the first dimension. For example, in one or more embodiments, the tabs 162 may be slid into the slots 160, and then the openings 130 of the cover 120 may be aligned with the retention apparatus 140 to engage the cover 120 with the retention apparatus 140. As shown in FIG. 1B, the cover 120 may include the tabs 162 and the chassis 102 may include the slots 160 (e.g., also shown in FIG. 2) configured to receive the tabs 162.

The slots 160 and tabs 162 may be located proximate any suitable position relative to the cover 120. For example, the slots 160 and tabs 162 may be located on an edge opposite the retention apparatus 140 and the openings 130. Specifically, the openings 130 of the cover 120 may be located proximate the first end region 122 (e.g., the front end region) of the cover 120 and the tabs 162 or slots 160 may be located proximate the second end region 124 (e.g., the rear end region) of the cover 120. As such, the cover 120 may be supported on one end by the retention apparatus 140 and on an opposite end by the slots 160 and tabs 162. Also, in one or more embodiments, the chassis 102 may include pads or bumpers (e.g., rubber, foam, etc.) upon which the cover 120 may rest proximate the slots 160 and the tabs 162.

Further, the slots 160 and tabs 162 may include any suitable number of each. For example, the vehicle 100 may include one, two, three, four, etc. sets of corresponding slots/tabs. As shown in FIG. 1B, the cover 120 includes two tabs 162 and the chassis 102 includes two slots 160 corresponding thereto. The tabs 162 may be positioned proximate each corner of the cover 120 along the rear edge of the cover 120 (e.g., the left-rear and right rear corners), and the corresponding slots 160 may be positioned to receive the tabs 162 located proximate the corners of the cover 120.

The vehicle 100 may also include any suitable number of retention apparatus 140. For example, the vehicle 100 may include one, two, three, four, etc. retention apparatus 140. As shown in FIG. 1B, the vehicle 100 includes three retention apparatus 140 and three corresponding openings 130. Each of the retention apparatus 140 and the corresponding openings 130 are located proximate the first end region 122 (e.g., the front end region) of the cover 120 (e.g., supporting the opposite side of the cover 120 from the slots 160/tabs 162). As shown, one of the retention apparatus 140 is centered between the left and right sides of the cover 120, and the other two retention apparatus are located proximate the left and right sides (e.g., near the front corners of the cover 120).

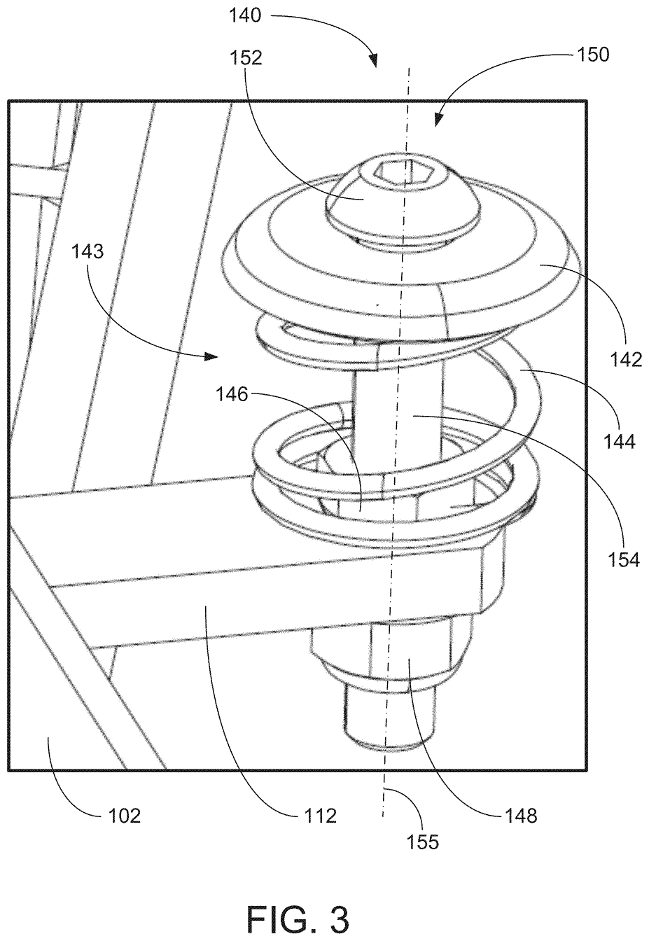

The retention apparatus 140 may be operably coupled to the chassis 102 as shown in FIG. 2 (e.g., proximate the front end of the vehicle 100). Further, as shown in FIG. 3 (e.g., FIG. 3 illustrates one representative retention apparatus 140), a portion of the retention apparatus 140 may be fixedly coupled to a frame bar 112 of the chassis 102 (e.g. for each retention apparatus 140). As described herein, a portion of the retention apparatus 140 may be configured to move relative to the chassis 102 (e.g. the frame bar 112) and another portion of the retention apparatus 140 may be configured to be fixed relative to the chassis 102 (e.g., the frame bar 112). The frame bar 112 may be described as a rigid structural portion (e.g., a metal tubing) of the chassis 102 that extends from another portion of the chassis 102 to position the retention apparatus 140 relative to the cover 120.

The retention apparatus 140 may include various components that interact with the cover 120 to removably secure the cover 120 to the chassis 102. For example, the retention apparatus 140 may include an elongated member 150 (e.g., a fastener, a bolt, a shaft, a rod, a pin, etc.) and a cap 142 (e.g., a washer), as shown in FIG. 3. Further, the elongated member 150 may include a head portion 152 (e.g., a fastener head, a knob, a wingnut, a screw head, a nut head, a bolt head, etc.) and a shank 154 extending from the head portion 152. The elongated member 150 may be fixedly coupled (e.g., fastened) to the chassis 102 (e.g., the frame bar 112). In other words, the elongated member 150 may remain in a static position relative to the chassis 102.

The elongated member 150 may be fixedly coupled to the chassis 102 in any suitable way. For example, as shown in FIG. 3, the shank 154 of the elongated member 150 may be fixedly coupled to the frame bar 112 of the chassis 102. Specifically, the shank 154 of the elongated member 150 may pass through an aperture of the frame bar 112 and may be secured relative thereto. In one or more embodiments, the retention apparatus 140 may include an upper securement 146 (e.g., a nut, a fastener, a stopper, etc.) coupled to the shank 154 (e.g., via threads) above the frame bar 112 and a lower securement 148 (e.g., a nut, a fastener, a stopper, etc.) coupled to the shank 154 (e.g., via threads) below the frame bar 112. Therefore, the upper and lower securements 146, 148 may maintain the elongated member 150 in position (e.g., fix a location) relative to the chassis 102 (e.g., the frame bar 112). For example, the upper securement 146 may prevent the elongated member 150 from moving downward through the aperture of the frame bar 112 (e.g., due to gravity) and the lower securement 148 may prevent the elongated member 150 from moving upward through the aperture of the frame bar 112 such that the elongated member 150 is locked into place.

The cap 142 may be movably connected to the elongated member 150 and, thereby, movably connected to the chassis 102. In other words, the cap 142 may move relative to both the elongated member 150 and the chassis 102 to assist in removably securing the cover 120 to the chassis 102. Further, the cap 142 may be positioned between the head portion 152 and the chassis 102 (e.g., the frame bar 112). The cap 142 may also be configured to be biased towards the head portion 152 of the elongated member 150 (e.g., away from the frame bar 112). In other words, the cap 142 may be dispositioned to move towards the head portion 152 and a force must be applied to move the cap 142 away from the head portion 152. Specifically, the cap 142 may be biased to move towards the head portion 152 along an axis 155 defined by the shank 154.

The cap 142 may be biased to move towards the head portion 152 by any suitable components. For example, the cap 142 may be operably coupled to a biasing member 143 such that the cap 142 moves along with the biasing member 143. The biasing member 143 may include any suitable component or structure that is compressible and provides a biasing force (e.g., parallel to the axis 155 of the elongated member 150). For example, the biasing member 143 may include a spring, pneumatic system, elastic material, compressible structure, compressible donut, beveled washer, wave washer, etc. Specifically, as shown in FIG. 3, the biasing member may include a spring 144 that may be operably connected to the cap 142 to bias the cap 142 towards the head portion 152. Further, the spring 144 may be positioned (e.g., operably connected) between the chassis 102 (e.g., the frame bar 112) and the cap 142 to force the cap 142 away from the chassis 102 (e.g., towards the head portion 152).

The cap 142 may define any suitable shape positioned between the head portion 152 and the chassis 102. For example, the cap 142 may define a shape that at least partially surrounds the shank 154 of the elongated member 150 such that the cap 142 may move along the shank 154. As shown in FIG. 3, the cap 142 defines a cap opening extending through the cap 142 and configured to receive the shank 154 (e.g., an opening through which the shank 154 is positioned). Also, the cap opening may be configured to deny passage of the head portion 152 of the elongated member 150. As such, the cap 142 is biased towards head portion 152 and stopped at the head portion 152 because the head portion 152 cannot pass through the cap opening.

The cap 142 and the head portion 152 may be configured to apply a clamping force therebetween due to the biasing force applied to the cap 142 and the positioning of the cap 142 relative to the head portion 152. Therefore, the retention apparatus 140 may be positioned relative to the associated opening 130 such that the head portion 152 is positioned on one side of the cover 120 and the cap 142 on the other side of the cover 120. For example, the head portion 152 may contact (e.g., direct contact) the outer surface 128 of the cover 120 and the cap 142 may contact (e.g., direct contact) the inner surface 126 of the cover 120. In other words, the head portion 152 and the cap 142 may apply force to each of the opposite surfaces (e.g., the outer and inner surfaces 128, 126) proximate the same location of the cover 120 (e.g., directly opposing forces). The clamping or opposing forces of the head portion 152 and the cap 142 on the cover 120 may restrict movement of the cover 120 relative to the chassis 102.

Further, the openings 130 may define a specific shape to interact with the retention apparatus 140 in such a way to allow for the cap 142 and the head portion 152 to be positioned proximate opposing surfaces of the cover 120 to apply a force thereto. For example, each opening 130 may be defined by multiple portions that interact with different portions of the retention apparatus 140 in different ways. As shown in FIGS. 4A and 4B, the opening may include a first opening 132 and a second opening 134 extending from the first opening 132 (e.g., the opening is continuous therebetween).

The size and dimensions of the first opening 132 is different than the second opening 134. For example, the first opening 132 of the opening 130 may be configured to permit passage of the head portion 152 therethrough and deny passage of the cap 142 (e.g., the cap 142 is restricted or obstructed from passing therethrough). In other words, the head portion 152 may define a shape that is allowed to pass through the first opening 132 (e.g., clearance between edges of the head portion 152 and first opening 132), while a shape of the cap 142 is not allowed to pass through the first opening 132. Therefore, the head portion 152 passes through the first opening 132 to be positioned on a side of the cover 120 proximate the outer surface 128 while the cap 142 remains on the other side of the cover 120 proximate the inner surface 126.

The second opening 134 of the opening 130 may be configured to deny passage of both the head portion 152 and the cap 142. In other words, the head portion 152 may define a shape that is not allowed to pass through the second opening 134 and the cap 142 may define a shape that is not allowed to pass through the second opening 134. As such, when the retention apparatus 140 (e.g., the shank 154 and the head portion 152) extends through the opening 130 and moved from being proximate the first opening 132 to proximate the second opening 134, the retention apparatus 140 is retained within the second opening 134. For example, the shank 154 of the elongated member 150 may be permitted to pass through the opening 130 and translated from extending through the first opening 132 to extending through the second opening 134. In other words, the shank 154 of the elongated member 150 may be sized relative to the second opening 134 such that the shank 154 may be positioned within the second opening 134. Therefore, the retention apparatus 140 (e.g., a portion thereof) may be moved into and out of the opening 130 when proximate the first opening 132 and the retention apparatus 140 cannot be moved through the opening 130 when proximate the second opening 132 (e.g., whether or not the shank 154 is positioned in the second opening 132).

In one or more embodiments, the openings 130 may define a keyhole shape opening. For example, the first opening 132 (e.g., a first portion) of the opening 130 may define a head opening (e.g., a circular opening) and the second opening 134 (e.g., a second portion) of the opening 130 may define a slot opening extending from the head opening. Specifically, the first opening 132 (e.g., the head opening) may define a diameter and the second opening 134 (e.g., the slot opening) may define a width that is less than the diameter. As such, the head portion 152 may define a maximum cross dimension that is less than the diameter of the first opening 132 (e.g., such that the head portion 152 may pass through the first opening 132). Also, the cap 142 may define at least one dimension that is greater than the diameter of the first opening 132 (e.g., such that the cap 142 cannot pass through the first opening 132). Further, the width of the second opening 134 (e.g., the slot opening) may be less than any cross dimension defined by either of the head portion 152 and the cap 142 (e.g., such that neither the head portion 152 nor the cap 142 can pass through the second opening 134). Further yet, the diameter of the shank 154 of the elongated member 150 may be less than the width of the second opening 134 (e.g., such that the shank 154 may move along and be positioned in the second opening 134).

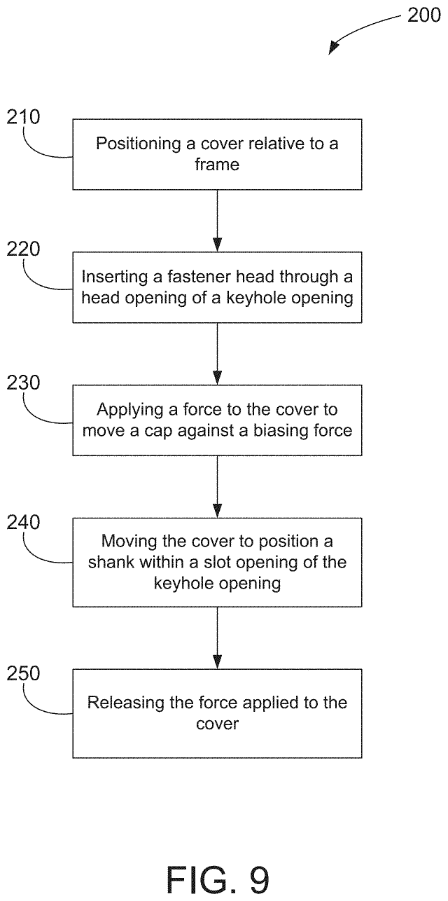

The method 200 of securing the cover 120 to the chassis 102 using the retention apparatus 140 in combination with the openings 130 is illustrated in FIG. 9. For example, the method 200 may include positioning 210 the cover 120 relative to the chassis 102. Specifically, the elongated member 150 (e.g., the head portion 152) may be aligned with the first opening 132 of the opening 130 as shown in FIG. 5. Further, each of the retention apparatus 140 may be aligned with the corresponding opening 130 (e.g., a first retention apparatus aligned with a first cover opening, a second retention apparatus aligned with a second cover opening, etc.). The cap 142 may also be aligned with the first opening 132, but due to the sizing and dimensions of the cap 142 and the first opening 132, the cap 142 may be prevented from passing through the first opening 132.

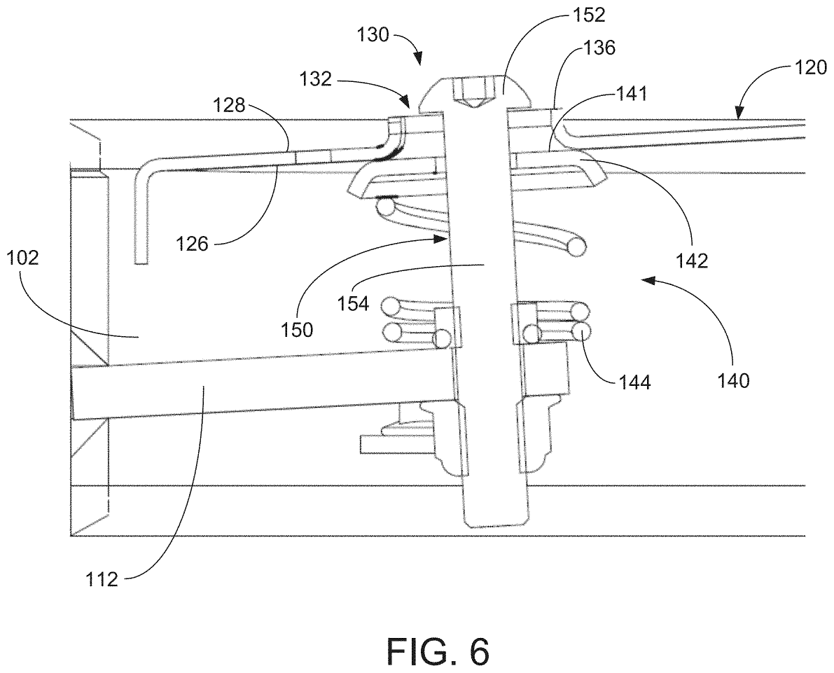

Additionally, the method 200 may also include inserting 220 the head portion 152 of the elongated member 150 through the first opening 132 of the opening 130 and applying 230 a force to the cover 120 to move the cap 142 against the biasing force. Specifically, a generally downward force may be applied to the cover 120 (e.g., the outer surface 128) to push the cap 142 against the biasing force provided by the biasing member 143 (e.g., spring 144) and move the head portion 152 through the first opening 132 as shown in FIG. 6. The inner surface 128 of the cover 120 may contact a top surface 141 of the cap 142 to move the cap 142 downward and compress the biasing member 143. It is noted that the force applied by the weight of the cover 120 is not enough to overcome the biasing force of the spring(s) 144 by itself. In other words, the spring(s) 144 do not compress without an external force applied to the cover 120.

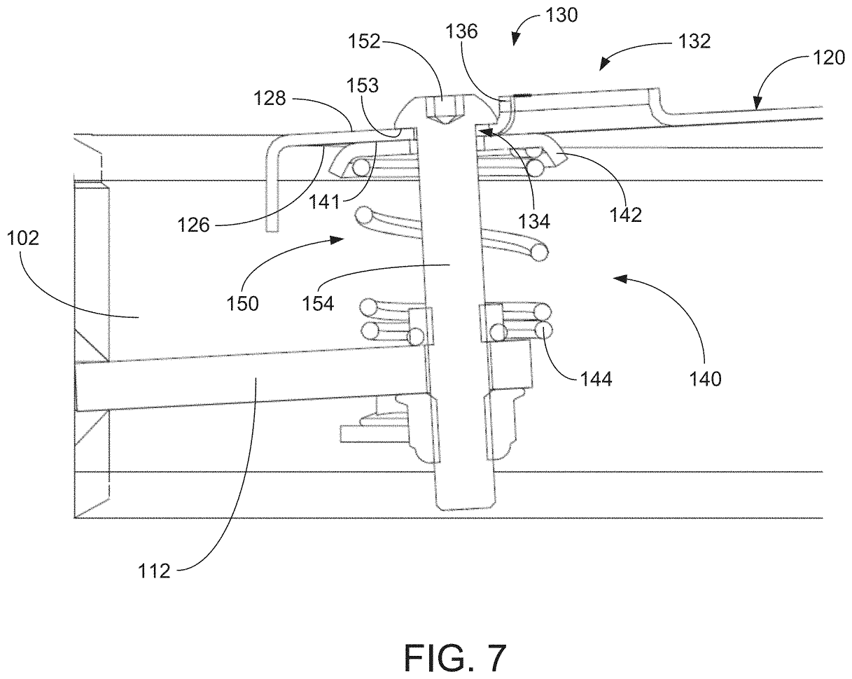

The method 200 may further include moving 240 the cover 120 to position the shank 154 of the elongated member 150 within the second opening 134 of the opening 130 and releasing 250 the force applied to the cover 120 (e.g., releasing the downward force applied to the outer surface 128 of the cover 120) as shown in FIG. 7. After the force applied to the cover 120 is released, the biasing force applied to the cap 142 (e.g., applied by the biasing member 143) moves the cap 142 into contact with the inner surface 126 of the cover 120. Further, the biasing force moves the cover 120 upwards and into contact with the head portion 152. Specifically, an underside 153 of the head portion 152 may contact the outer surface 128 of the cover 120 due to the biasing force applied to the cover 120 by the cap 142. Therefore, the cap 142 and the head portion 152 may apply a force (e.g., opposing forces) to the cover 120 to maintain the cover 120 in a position relative to the chassis 102.

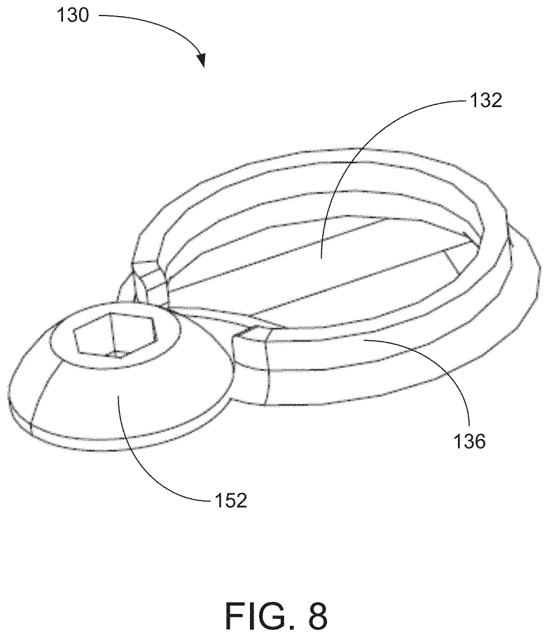

Furthermore, in one or more embodiments, the cover 120 may include a ridge 136 surrounding at least a portion of the first opening 132 and extending (e.g., outward) from the outer surface 128 of the cover 120, e.g., as shown in FIGS. 7 and 8 (e.g., also shown in FIGS. 4A, 4B, 5, and 6). The ridge 136 may restrict movement of the head portion 152 from the second opening 134 to the first opening 132 when the head portion 152 is in contact with the outer surface 128 of the cover 120 (e.g., after the applied force is released from the cover 120 to compress the biasing force). In other words, after the head portion 152 is positioned relative to the second opening 134 and the biasing force moves the head portion 152 and the cap 142 into contact with the cover, the head portion 152 is prevented from sliding back to the first opening 132 (and, e.g., passing therethrough) by the ridge 136.

In one or more embodiments, the cover 120 may be initially positioned relative to the chassis 102 using the slots 160 and tabs 162, as described herein. For example, the tabs 162 of the cover 120 may be received by the slots 160 (e.g., as shown in FIG. 2) of the chassis 102 to locate a portion (e.g., the second end region 122) of the cover 120. After positioning the portion of the cover 120, the retention apparatus 140 may be engaged with the cover 120 (e.g., as described herein) to releasably couple the cover and the chassis 102. Further, inserting the tabs 162 into the slots 160 may restrict movement of the cover 120 in two orthogonal dimensions and engaging the retention apparatus 140 with the cover 120 may restrict movement of the cover 120 in the third orthogonal dimension to secure the cover 120 into position.

Furthermore, the cover 120 may be removed from the chassis 102 by disengaging the retention apparatus 140 from openings 130 of the cover 120. For example, a force may be applied (e.g., a downward force) to the cover 120 to move the cap 142 against the biasing force (e.g., the spring 144) to space the head portion 152 away from the cover 120 (e.g., away from the outer surface 128). Next, the cover 120 may be moved to align the head portion 152 with the first opening 132 of the openings 130. It is noted that the force applied to the cover 120 may be great enough such that the head portion 152 may clear the ridge 136 when moving the head portion 152 to align with the first opening 132. Finally, the force applied to the cover 120 may be released such that the head portion 152 may pass through the first opening 132 of the openings 130 to disengage the cover 120 from the retention apparatus 140. In other words, retention apparatus 140 may no longer be positioned on either side of the cover 120 (e.g., with the head portion 152 proximate the outer surface 128 and the cap 142 proximate the inner surface 126). In one or more embodiments, the tabs 162 may be removed from the slots 160 after the retention apparatus 140 is disengaged from the cover 120 so that the cover 120 may be removed from the chassis 102.

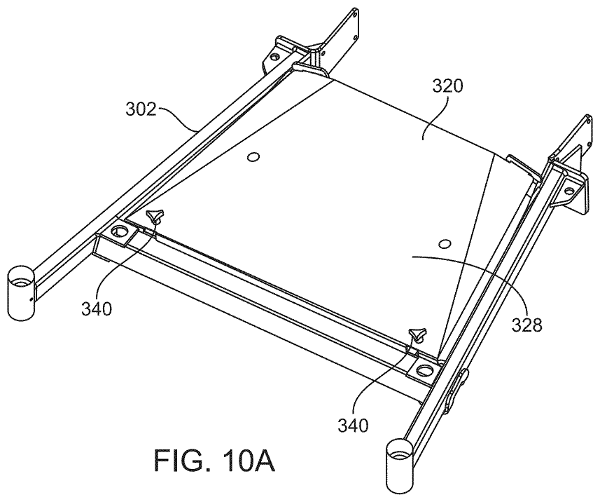

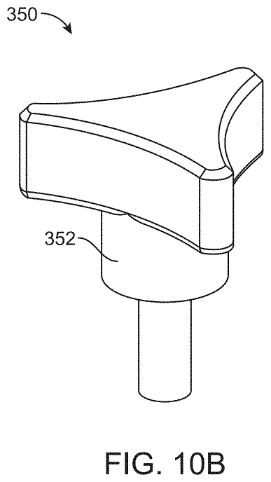

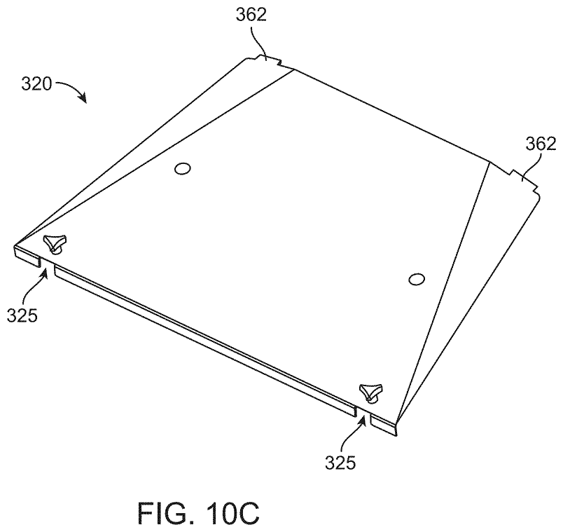

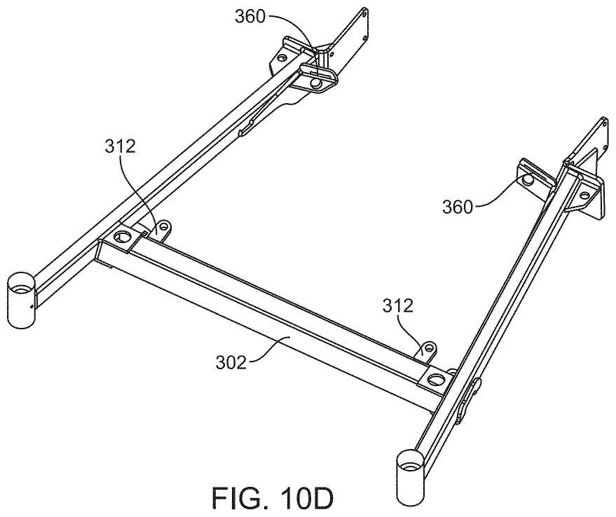

FIGS. 10A-10D illustrate another embodiment of a retention apparatus 340 for attaching and securing a cover 320 to a portion of a frame 302 of a grounds maintenance vehicle (full vehicle not shown, but similar to vehicle 100 illustrated in FIG. 1A). For example, the retention apparatus 340 may include an elongated member 350 (e.g., a fastener, a bolt, a shaft, a rod, a pin, etc.) that extends through the cover 320 and is removably couplable to the frame 302 of the vehicle. Specifically, the elongated member 350 may be configured to be removably coupled to a portion of the frame 302 (e.g., the frame bar 312 shown in FIG. 10D). Further, the elongated member 350 (e.g., as shown isolated in FIG. 10B) may include a head portion 352 (e.g., a fastener head, a knob, a wingnut, a screw head, a nut head, a bolt head, etc.) that is configured to contact the cover 320 (e.g., an outer surface 328) to apply a force thereto to secure the cover 320 to the frame 302. Also, the cover 320 may rest on a portion of the frame 302 (e.g., the frame bar 312) such that the cover 320 is positioned and secured between the portion of the frame 302 and the head portion 352. Therefore, vertical motion of the cover 320 may be restricted by the presence of the portion of the frame 302 and the head portion 352, and horizontal motion of the cover 320 may be restricted by the elongated member 350 extending through the cover 320 (e.g., through an opening that is sized to receive the elongated member 350).

The elongated member 350 and the head portion 352 may include any suitable components that assist in attaching and securing the cover 320 to the frame 302. For example, the elongated member 350 may include a threaded fastener, a rod with openings, a rod with a taper, a nodule, a shaft, a pin, etc. and the head portion 352 may include a fastener head, a knob, a wingnut, a screw head, a nut head, a bolt head, etc. As shown in FIG. 10B, the head portion 352 includes a knob head having three protrusions evenly spaced around the axis.

The portion of the frame 302 corresponding to the elongated member 350 (e.g., to receive the elongated member 350) may include any suitable components that interact with the elongated member 350. For example, the portion of the frame 302 (e.g., the frame bar 312) may include clinch nuts, a recess, clips, tapers, clamps, etc. As such, the cover 320 may be positioned relative to the frame 302 such that the frame bar 312 is aligned with openings of the cover 320 and the elongated member 350 is inserted through the openings to attach and secure the cover 320 to the frame 302.

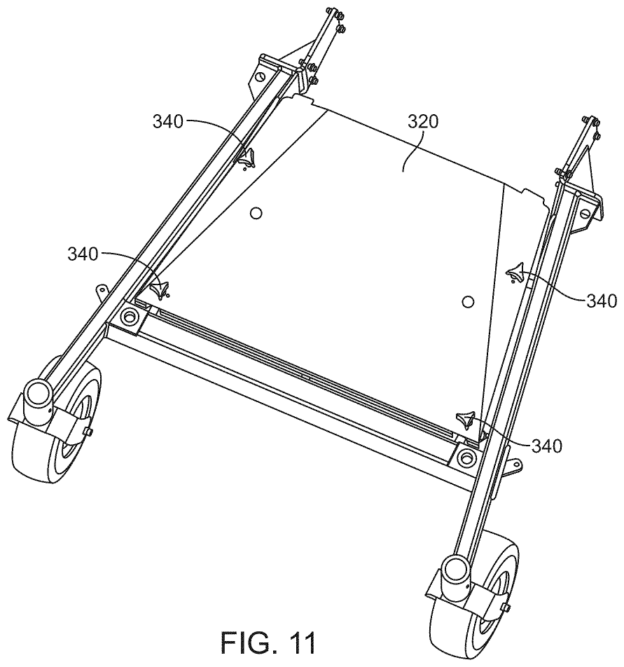

The vehicle may include any suitable number of retention apparatus 340. For example, as shown in FIG. 10A, the vehicle may include two retention apparatus 340 positioned proximate a front end region of the cover 320. As shown in FIG. 11, the vehicle may include four retention apparatus 340 (and four corresponding frame bars 312). The retention apparatus 340 shown in FIG. 11 may equally support each corner of the cover 320. In other embodiments, the vehicle may include one, three, five, six, etc. retention apparatus 340.

In one or more embodiments, the cover 320 may define cutouts 325 (e.g., as shown in FIG. 10C) that correspond with the frame bars 312 of the frame 302. For example, cutouts 325 may allow for the cover 320 to be positioned lower relative to the frame 302 such that the frame bars 312 may support an inner surface of the cover 320.

Additionally, in one or more embodiments, the cover 320 may be set into position using tabs 362 and slots 360 (e.g., similar to as illustrated and described in relation to FIGS. 1B and 2). For example, the cover 320 may be generally located relative to the frame 302 using the tabs 362 and slots 360 and then may be removably coupled to the frame 302 using the retention apparatus 340. Specifically, the slots 360 may be configured to receive the tabs 362 and properly position the retention apparatus 340. As shown in FIG. 10C, the cover 320 may include the tabs 362 and, as shown in FIG. 10D, the frame may include the slots 360 configured to receive the tabs 362. In embodiments including tabs 362 and slots 360, the retention apparatus 340 may only be present proximate the front end region of the cover 320 (e.g., because the tabs 362 and slots 360 may support the rear end region of the cover 320). Also, in embodiments including four retention apparatus 340 spaced proximate each corner of the cover 320 (e.g., as shown in FIG. 11), the vehicle may not utilize any slots and tabs as described herein.

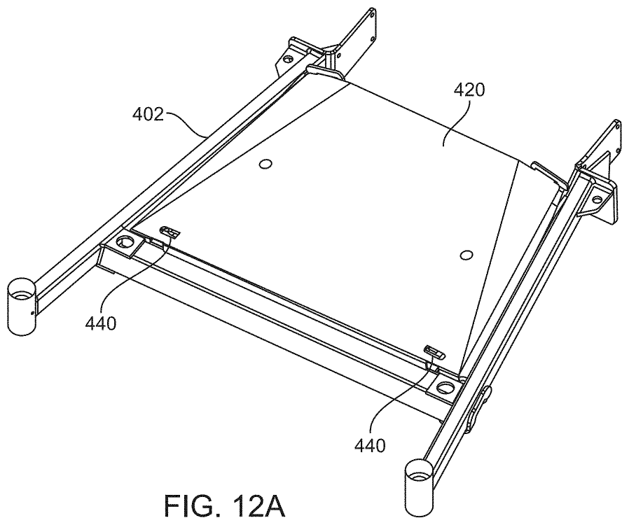

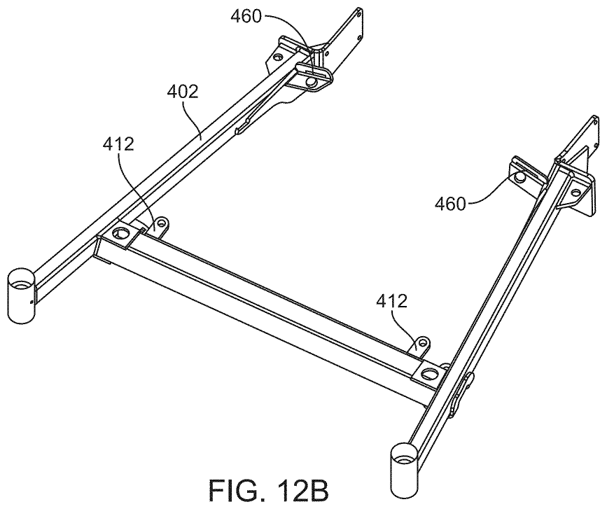

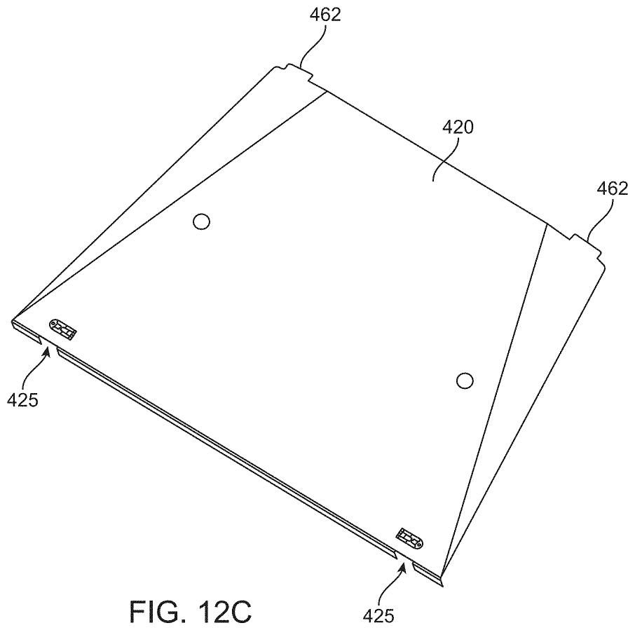

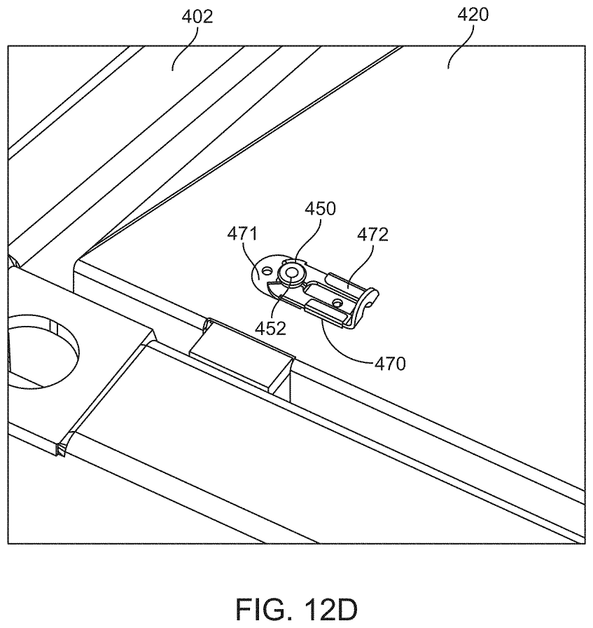

FIGS. 12A-12D illustrate yet another embodiment of a retention apparatus 440 for attaching and securing a cover 420 to a portion of a frame 402 of a grounds maintenance vehicle (full vehicle not shown, but similar to vehicle 100 illustrated in FIG. 1A). For example, the retention apparatus 440 may include an elongated member 450 (e.g., a fastener, a bolt, a shaft, a rod, a pin, a bolt, etc.) attached to the frame 402 (e.g., to a frame bar 412) and a slide latch 470 attached to the cover 420 (e.g., as shown in FIG. 12D). The elongated member 450 may be positioned relative to the frame 402 and extend through the cover 420 (e.g., through an opening in the cover 420) such that the elongated member 450 may interact with the slide latch 470. For example, the elongated member 450 may include a head portion 452 (e.g., a fastener head, a knob, a wingnut, a screw head, a nut head, a bolt head, etc.) that interacts with the slide latch 470 between a locked position and an unlocked position. In the locked position, the head portion 452 may interact with the slide latch 470 such that the head portion 452 may be restricted from moving relative to the slide latch 470 and, thereby, the cover 420 may be restricted from moving relative to the frame 402. In the unlocked position, the head portion 452 may be free to move relative to an opening in the cover 420 to attach or remove the cover 420 to the frame 402.

The slide latch 470 may be biased into the locked position so that when no external forces are applied to the retention apparatus 440, the cover 420 may be restricted from moving relative to the frame 402 (e.g., when the slide latch 470 is engaged by the elongated member 450). In other words, the operator may move the slide latch 470 (and hold the slide latch 470) into the unlocked position to allow the elongated member 450 to move freely relative to the slide latch 470. Therefore, when the head portion 452 is in position to interact with the slide latch 470, such that the cover 420 is attached and secured to the frame 402, the cover 420 may not inadvertently detach from the frame 402 (e.g., because the locked position is the biased position). Further, in one or more embodiments, the head portion 452 may be inserted into the slide latch 470 when the slide latch 470 is in the locked position to engage therewith (e.g., due to a taper of the head portion 452 or slide latch 470) so that the operator does not have to move the slide latch 470 to the unlock position to insert the head portion 452. However, once the head portion 452 is engaged with the slide latch 470, the slide latch 470 may revert to the locked position so that the head portion 452 cannot be removed (e.g., at least not without an external force applied to the slide latch). In other words, the head portion 452 may move in one direction when the slide latch 470 is in the locked position (e.g., to insert the head portion 452 but not to remove the head portion 452).

The slide latch 470 may include any suitable components to interact with the head portion 452 as described herein. For example, in one or more embodiments, the slide latch 470 may include a first bracket 471 fixedly coupled to the cover 420 and a second bracket 472 that is movably coupled to the first bracket 471 (e.g. as shown in FIG. 12D). Therefore, the second bracket 472 may move relative to the first bracket 471 to interact with the head portion 452. Specifically, the second bracket 472 may apply a force to the elongated member 450 such that the elongated member 450 contacts at least a portion of the first bracket 471 and at least a portion of the second bracket 472. Further, the second bracket 472 may include prongs extending on either side of the elongated member 450 that restrict the head portion 452 from passing by the prongs (e.g., to remove the cover 420) when the second bracket 472 is positioned around the head portion 452 in the locked position.

Specifically, in one or more embodiments, the slide latch 470 may be biased into the locked position because the second bracket 472 is biased to move relative to first bracket 471. For example, the slide latch 470 may include a spring to bias the second bracket 472. The biasing of the slide latch 470 may create a clamping between the first and second brackets 471, 472 to restrict movement of the elongated member 450 positioned therebetween.

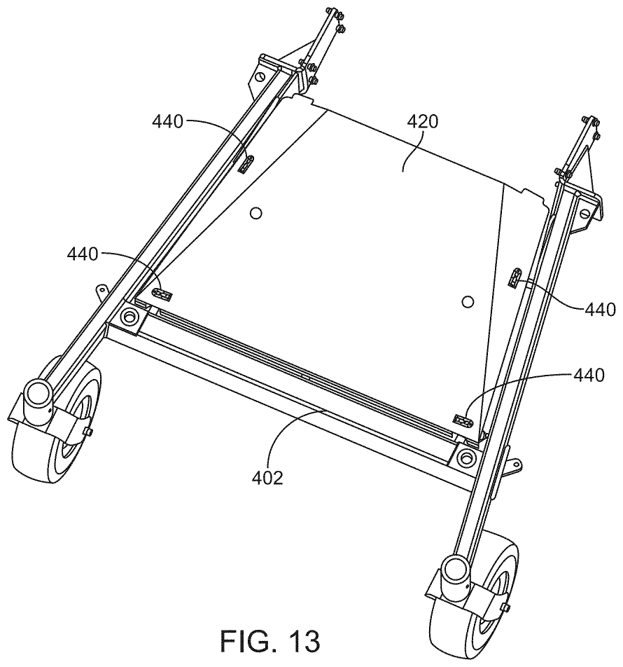

The vehicle may include any suitable number of retention apparatus 440. For example, as shown in FIG. 12A, the vehicle may include two retention apparatus 440 positioned proximate a front end region of the cover 420. As shown in FIG. 13, the vehicle may include four retention apparatus 440 (and four corresponding frame bars 412). The retention apparatus 440 shown in FIG. 13 may equally support each corner of the cover 420. In other embodiments, the vehicle may include one, three, five, six, etc. retention apparatus 440.

In one or more embodiments, the cover 420 may define cutouts 425 (e.g., as shown in FIG. 12C) that correspond with the frame bars 412 of the frame 402. For example, cutouts 425 may allow for the cover 420 to be positioned lower relative to the frame 402 such that the frame bars 412 may support an inner surface of the cover 420.

Additionally, in one or more embodiments, the cover 420 may be set into position using tabs 462 and slots 460 (e.g., similar to as illustrated and described in relation to FIGS. 1B and 2). For example, the cover 420 may be generally located relative to the frame 402 using the tabs 462 and slots 460 and then may be removably coupled to the frame 402 using the retention apparatus 440. Specifically, the slots 460 may be configured to receive the tabs 462 and properly position the retention apparatus 440. As shown in FIG. 12C, the cover 420 may include the tabs 462 and, as shown in FIG. 12B, the frame may include the slots 460 configured to receive the tabs 462. In embodiments including tabs 462 and slots 460, the retention apparatus 440 may only be present proximate the front end region of the cover 420 (e.g., because the tabs 462 and slots 460 may support the rear end region of the cover 420). Also, in embodiments including four retention apparatus 440 spaced proximate each corner of the cover 420 (e.g., as shown in FIG. 13), the vehicle may not utilize any slots and tabs as described herein

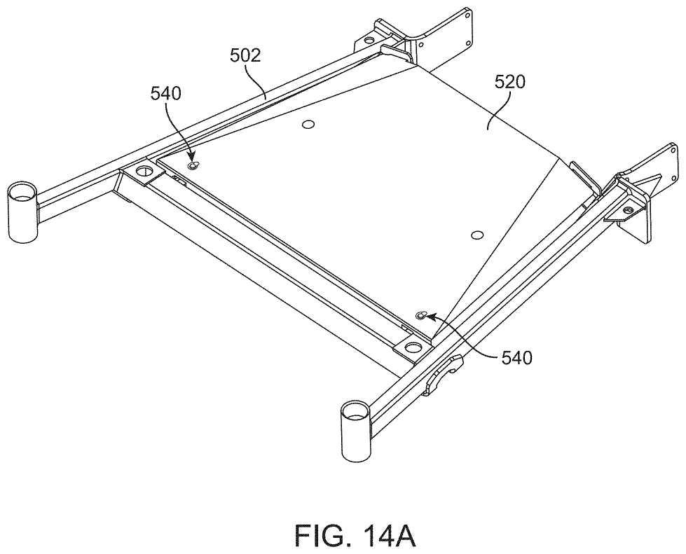

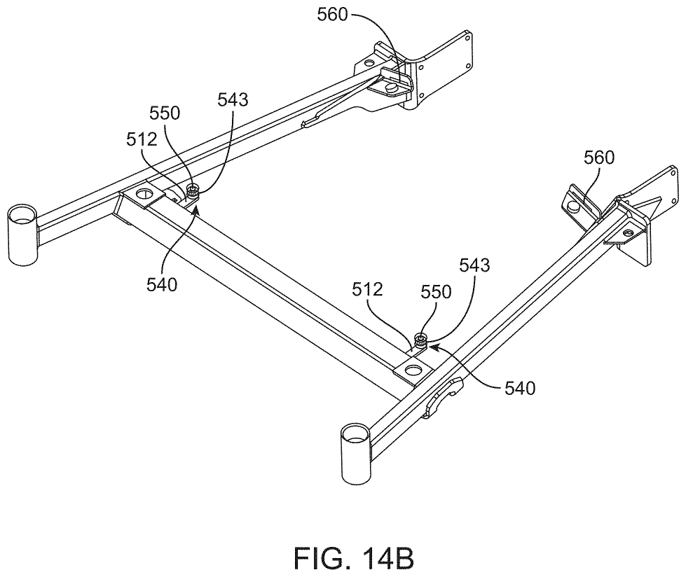

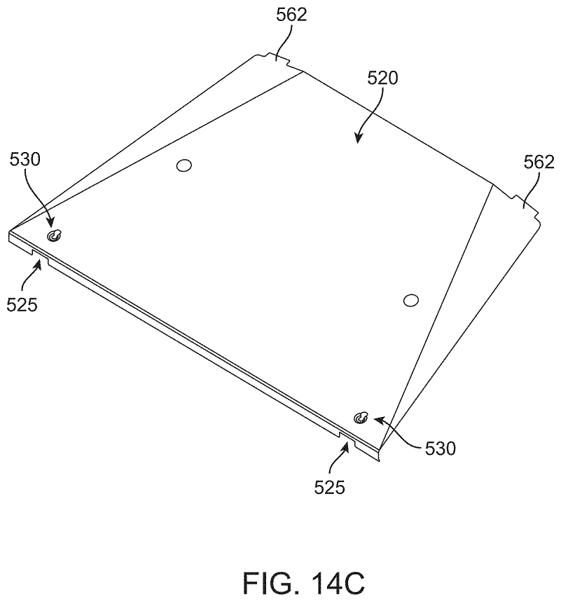

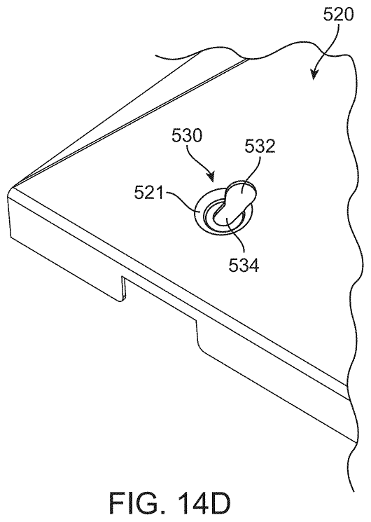

FIGS. 14A-14D illustrate yet another embodiment of a retention apparatus 540 for attaching and securing a cover 520 to a portion of a frame 502 of a grounds maintenance vehicle (full vehicle not shown, but similar to vehicle 100 illustrated in FIG. 1A). For example, as shown in FIG. 14B, the retention apparatus 540 may include an elongated member 550 (a fastener, a bolt, a shaft, a rod, a pin, etc.) and a biasing member 543. Specifically, the elongated member 550 and the biasing member 543 may be operatively attached to a frame bar 512 of the frame 502. For example, the elongated member 550 may extend into or through the frame bar 512 and the biasing member 543 may be fastened or adhered to the frame bar 512. Further, the biasing member 543 may be configured to be compressed and move relative to the elongated member 550. For example, the biasing member 543 may have a force applied in a downward direction to compress the biasing member 543 and the biasing member 543 may apply a reactionary force in the opposite direction. As such, the biasing member 543 may be biased to an extended position to move the biasing member 543 away from the frame bar 512. The biasing member 543 may include any suitable component or structure that is compressible and provides a biasing force (e.g., parallel to the axis of the elongated member 550). For example, the biasing member 543 may include a spring, pneumatic system, elastic material, compressible structure, compressible donut, beveled washer, wave washer, etc.

The cover 520 may define an opening 530, as shown in FIGS. 14C and 14D, that may be configured to receive the elongated member 550. For example, the cover 520 may be positioned relative to the frame 502 and the opening 530 may be aligned with the elongated member 550 such that the elongated member 550 may pass through the opening 530 when the cover 520 is moved towards the elongated member 550. The opening 530 of the cover 520 may define a keyhole shape opening and include a head opening 532 and a slot opening 534 extending from the head opening 532. The elongated member 550 may be shaped and sized to extend through both the head opening 532 and the slot opening 534.

Further, a head portion (e.g., similar to as described in relation to FIG. 3) of the elongated member 550 may extend through the head opening 532 and may be restricted from passing through the slot opening 534. Therefore, the elongated member 550 and head portion may pass through the head opening 532 and then the elongated member 550 may slide into the slot opening 534 (e.g., with the elongated member 550 extending through the slot opening 534) such that head portion is positioned on one side of the cover 520 and the biasing member 543 is positioned on the other side of the cover 520. As such, when the elongated member 550 is positioned within the slot opening 534, the cover 520 may be prevented from being removed from the frame 502 because of the head portion.

Additionally, the biasing member 543 of the retention apparatus 540 may be configured to apply a force to the cover 520 when the elongated member 550 is inserted through the opening 530 of the cover 520. For example, the biasing member 543 may come into contact with an inner surface of the cover 520 and apply a force thereon when the cover 520 is positioned over the retention apparatus 540. Further, the biasing member 543 may compress when an operator applies a downward force to the cover 520 and the elongated member 550 extends through the opening 530 (e.g., the head opening 532). Further yet, the cover 520 may be moved to position the elongated member 550 within the slot opening 534 and the operator may remove the downward force applied to the cover 520 such that the biasing member 543 forces the cover 520 upward. However, because the head portion may be restricted from passing through the slot opening 534, the cover 520 may remain attached to the frame 502 through the retention apparatus 540. In other words, the cover 520 may be retained between the biasing member 543 and the head portion due to the biasing force of the biasing member 543 applied to the cover 520 and the head portion restricting the cover 520 from moving further in the direction of the biasing force. Therefore, the cover 520 may be restricted from moving due to the opposing forces applied by the head portion and the biasing member 543.

Furthermore, in one or more embodiments, the cover 520 may define a recessed portion 521 at the slot opening 534 (e.g., as shown in FIG. 14D). In other words, the recessed portion 521 may be located along a planar surface that is different than the remainder of the cover 520. Specifically, the recessed portion 521 of the cover 520 containing the slot opening 534 may be located on a different plane than the portion of the cover 520 containing the head opening 532. Therefore, when the head portion is located proximate the slot opening 534 and in contact with the outer surface of the cover 520 (e.g., when the biasing member 543 is applying a force to the cover 520 without any external opposing force), the elongated member 550 may be restricted from sliding to the head opening 532. For example, the lip or ridge created by the recessed portion 521 may prevent the elongated member 550 from moving out of the slot opening 534. As such, the recessed portion 521 may prevent the cover 520 from being inadvertently detached from the frame 502 (e.g., due to bumps or jostling during operation of the vehicle).

The vehicle may include any suitable number of retention apparatus 540 and the cover 520 may define the same number of corresponding openings 530. For example, as shown in FIG. 14A, the vehicle may include two retention apparatus 540 and the cover 520 may define two openings 530 positioned proximate a front end region of the cover 520. In other embodiments, the vehicle may include one, three, four, five, six, etc. retention apparatus 540 and the same number of corresponding openings 530.

In one or more embodiments, the cover 520 may define cutouts 525 (e.g., as shown in FIG. 14C) that correspond with the frame bars 512 of the frame 502. For example, cutouts 525 may allow for the cover 520 to be positioned lower relative to the frame 502 such that the frame bars 512 may support an inner surface of the cover 520.

Additionally, in one or more embodiments, the cover 520 may be set into position using tabs 562 and slots 560 (e.g., similar to as illustrated and described in relation to FIGS. 1B and 2). For example, the cover 520 may be generally located relative to the frame 502 using the tabs 562 and slots 560 and then may be removably coupled to the frame 502 using the retention apparatus 540. Specifically, the slots 560 may be configured to receive the tabs 562 and properly position the retention apparatus 540. As shown in FIG. 14C, the cover 520 may include the tabs 562 and, as shown in FIG. 14B, the frame may include the slots 560 configured to receive the tabs 562. In embodiments including tabs 562 and slots 560, the retention apparatus 540 may only be present proximate the front end region of the cover 520 (e.g., because the tabs 562 and slots 560 may support the rear end region of the cover 520).

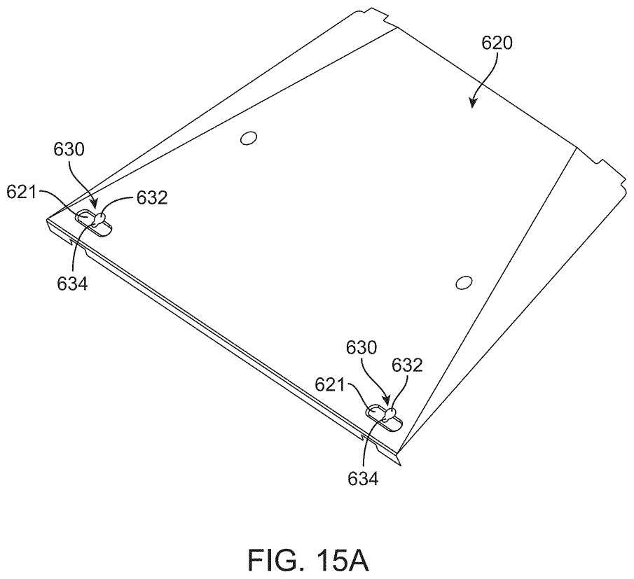

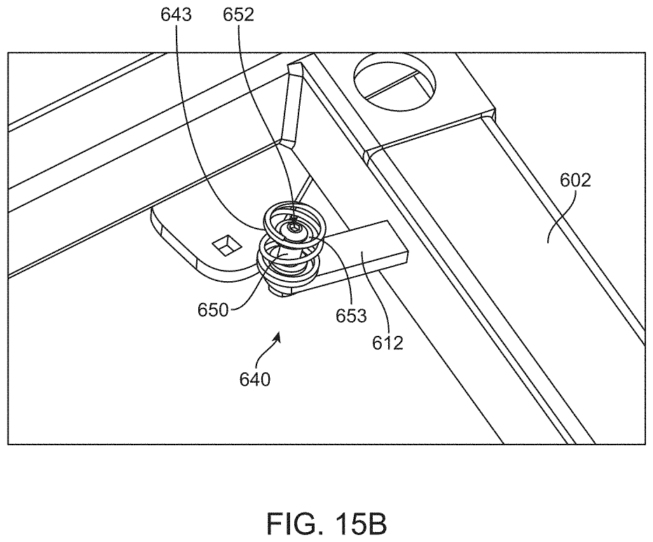

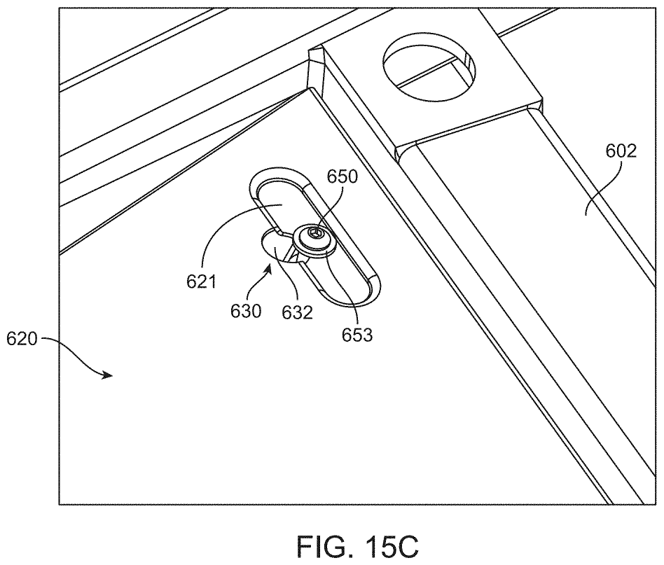

FIGS. 15A-15C illustrate yet another embodiment of a retention apparatus 640 for attaching and securing a cover 620 to a portion of a frame 602 of a grounds maintenance vehicle (full vehicle not shown, but similar to vehicle 100 illustrated in FIG. 1A). For example, similar to the embodiment illustrated in FIGS. 14A-14D, the retention apparatus 640 may include an elongated member 650 (e.g., a fastener, a bolt, a shaft, a rod, etc.) and a biasing member 643. The elongated member 650 and the biasing member 643 may be operatively attached to a frame bar 612 of the frame 602 (e.g., as shown in FIG. 15B). The retention apparatus 640 may include many of the same features as described in connection with FIGS. 14A-14D.

In addition to the features described in connection with FIGS. 14A-14D, the cover 620 may define a recessed portion 621 (e.g., proximate an opening 630) having an elongated oval shape, as shown in FIG. 15A.

Also, as shown in FIGS. 15B and 15C, the retention apparatus 640 may include a washer 653 located beneath a head portion 652 (e.g., a fastener head, a knob, a wingnut, a screw head, a nut head, a bolt head, etc.) of the elongated member 650. The washer 653 may increase the overall contact area between the head portion 652 and the cover 620. For example, as described herein, the head portion 652 (and washer 653) may pass through a head opening 632 of the opening 630 defined by the cover 620, but the washer 653 may be restricted from passing through a slot opening 634 (shown in FIG. 15A) of the opening 630. Therefore, the washer 653 may increase the contact area between the head portion 652 and the cover 620 proximate the slot opening 634.

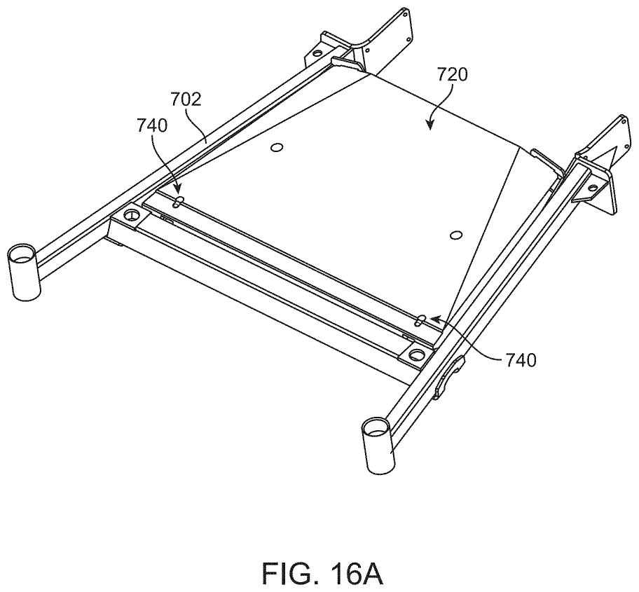

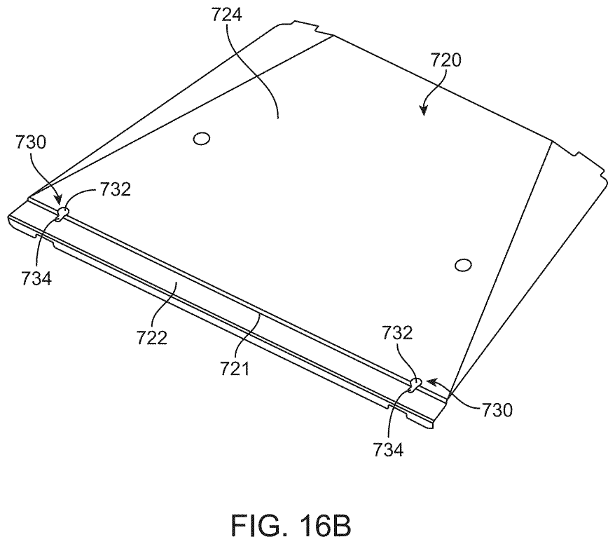

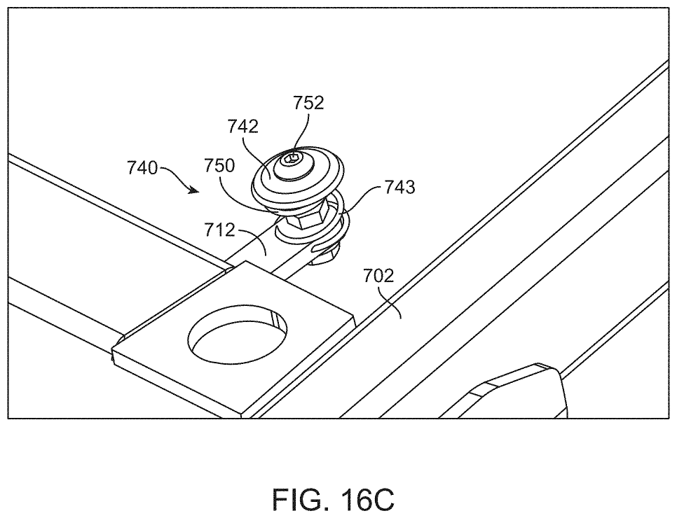

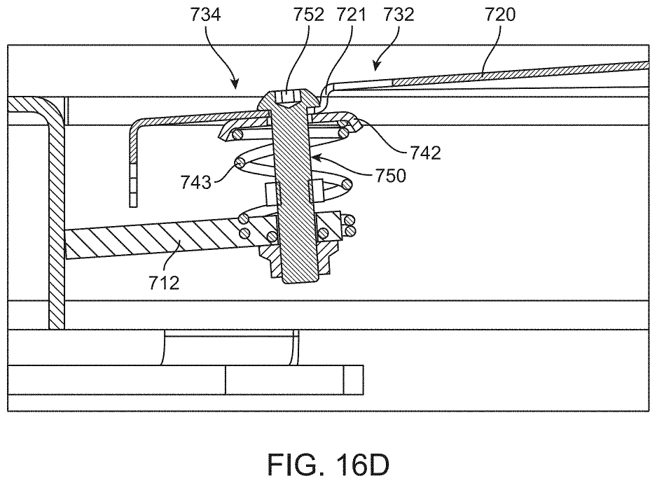

FIGS. 16A-16D illustrate yet another embodiment of a retention apparatus 740 for attaching and securing a cover 720 to a portion of a frame 702 of a grounds maintenance vehicle (full vehicle not shown, but similar to vehicle 100 illustrated in FIG. 1A). For example, similar to the embodiments illustrated in FIGS. 14A-14D, the retention apparatus 740 may include an elongated member 750 (e.g., a fastener, a bolt, a shaft, a rod, a pin, etc.) and a biasing member 743. The elongated member 750 and the biasing member 743 may be operatively attached to a frame bar 712 of the frame 702 (e.g., as shown in FIG. 16C). In addition to the features described in connection with FIGS. 14A-14D, the retention apparatus 740 may also include a cap 742 operatively attached to the biasing member 743 (e.g., as shown in FIG. 16C). As such, the cap 742 may move along with the biasing member 743 when compressed and returning to its initial position.

Similar to the cap described in connection with FIGS. 3 and 5-7, the cap 742 may be sized and shaped such that the cap 742 is restricted from passing through the opening 730 (e.g., the head opening 732 and the slot opening 734). Therefore, as shown in FIG. 16D, the cap 742 may apply a force to the inner surface of the cover 720 to retain the cover 720 between the cap 742 and a head portion 752 (e.g., a fastener head, a knob, a wingnut, a screw head, a nut head, a bolt head, etc.) of the elongated member 750. The cap 742 may define a flat, large surface area to apply a pressure to the inner surface of the cover 720 (e.g., as compared to a top edge of only the biasing member 743).

In addition to the features described in connection with FIGS. 14A-14D, the cover 720 may define a ridge 721 extending transversely and across openings 730 defined by the cover 720, as shown in FIG. 16B. The cover 720 may be separated into two separate portions extending along different planes that are connected at the ridge 721. For example, a first portion 722 of the of the cover 720 (e.g., near a front end region of the cover 720) may extend along a first planar surface and a second portion 724 of the cover 720 may extend along a second planar surface that is different than the first planar surface and separated therefrom by the ridge 721 defining a vertical section. In one or more embodiments, the first portion 722 may extend a lower planar height than the second portion 724.

Additionally, similar to as described herein in connection with other embodiments, the cover 720 may define a keyhole-shaped opening 730 having a head opening 732 and a slot opening 734 extending from the head opening 732. Specifically, the head opening 732 may be located on the second portion 724 and the slot opening 734 may be located on the first portion 722. Therefore, as shown in FIG. 16D, when a head portion 752 of the elongated member 750 is in contact with the cover 720 and located proximate the slot opening 734 (e.g., the head portion 752 may be restricted from passing through the slot opening 734 due to size and shape), the head portion 752 may be prevented from sliding to the head opening 732 (and, e.g., passing therethrough) because of the ridge 721 (e.g., physically restricted by contact with the ridge 721).

Illustrative embodiments are described and reference has been made to possible variations of the same. These and other variations, combinations, and modifications will be apparent to those skilled in the art, and it should be understood that the claims are not limited to the illustrative embodiments set forth herein.

What is claimed is:

1. A grounds maintenance vehicle comprising:
a frame carrying a prime mover and extending along a longitudinal axis between a front end and a rear end;
ground engaging members operatively attached to the frame, wherein at least one of the ground engaging members is powered by the prime mover to propel the frame over a ground surface;
an implement attached to the frame;
a cover positioned over at least a portion of the implement, wherein the cover defines an inner surface, an outer surface opposite the inner surface, and an opening extending between the inner and outer surfaces; and
a retention apparatus operably coupled to the frame and corresponding to the opening, wherein the retention apparatus comprises a head portion and a biasing member, wherein the biasing member is configured to be biased towards the head portion, wherein the retention apparatus extends through the opening such that the head portion and the biasing member apply force to each of the opposite surfaces to restrict movement of the cover relative to the frame.

2. The grounds maintenance vehicle of claim 1, wherein the opening defines a keyhole shape, wherein the keyhole shape of the opening defines a head opening and a slot opening extending from the head opening.

3. The grounds maintenance vehicle of claim 1, wherein a first portion of the opening is configured to permit passage of the head portion therethrough and deny passage of the biasing member, wherein a second portion of the opening is configured to deny passage of both the head portion and the biasing member, and wherein the second portion of the opening extends from the first portion of the opening.

4. The grounds maintenance vehicle of claim 1, wherein the cover comprises a ridge surrounding at least a first portion of the opening and extending from the outer surface of the cover, wherein the ridge restricts movement of the head portion from a second portion of the opening to the first portion of the opening when the head portion is in contact with the outer surface of the cover.

5. The grounds maintenance vehicle of claim 1, wherein the retention apparatus further comprises a cap attached to the biasing member, wherein the biasing member is operably connected between the frame and the cap and configured to force the cap away from the frame and towards the head portion, wherein the cap is configured to contact the inner surface of the cover.

6. The grounds maintenance vehicle of claim 5, wherein the retention apparatus further comprises a shank extending from the head portion, wherein the cap is biased to move towards the head portion along an axis defined by the shank.

7. The grounds maintenance vehicle of claim 5, wherein the retention apparatus further comprises an elongated member including the head portion and a shank extending from the head portion, wherein the cap defines an opening through which the shank is positioned and the cap is configured to move relative to the elongated member along the shank, wherein the opening of the cap is configured to deny passage of the head portion.

8. The grounds maintenance vehicle of claim 1, wherein the head portion of the retention apparatus is fixedly coupled to a frame bar of the frame.

9. The grounds maintenance vehicle of claim 1, wherein the biasing member comprises a spring.

10. The grounds maintenance vehicle of claim 1, wherein the cover comprises one of a slot and a tab and the frame comprises the other of the slot and the tab, wherein the slot is configured to receive the tab to restrict movement of the cover in at least two orthogonal dimensions.

11. The grounds maintenance vehicle of claim 1, wherein the cover extends between a first end region proximate the front end of the frame and a second end region rearward of the first end region, wherein the opening is located proximate the first end region of the cover.

12. A grounds maintenance vehicle comprising:
a frame carrying a prime mover and extending along a longitudinal axis between a front end and a rear end;
ground engaging members operatively attached to the frame, wherein at least one of the ground engaging members is powered by the prime mover to propel the frame over a ground surface;
a cover positioned over at least a portion of the frame, wherein the cover defines an inner surface, an outer surface opposite the inner surface, and a keyhole opening, wherein the keyhole opening defines a head opening and a slot opening extending from the head opening; and
a retention apparatus operably coupled to the frame and corresponding to the keyhole opening, wherein the retention apparatus comprises an elongated member and a cap, wherein the elongated member comprises a head portion and a shank extending from the head portion, wherein the cap is configured to move relative to the elongated member along the shank,
wherein the head opening of the keyhole opening is configured to permit passage of the head portion therethrough and deny passage of the cap, and wherein the slot opening of the keyhole opening is configured to deny passage of both the head portion and the cap.

13. The grounds maintenance vehicle of claim 12, wherein the cap is configured to be biased towards the head portion, wherein the cap is configured to apply force to the inner surface of the cover proximate the slot opening and the head portion is configured to apply force to the outer surface of the cover proximate the slot opening to restrict movement of the cover relative to the frame.

14. The grounds maintenance vehicle of claim 12, wherein the cover comprises a ridge surrounding at least a portion of the head opening and extending from the outer surface of the cover, wherein the ridge restricts movement of the head portion from the slot opening to the head opening when the head portion is in contact with the outer surface of the cover.

15. The grounds maintenance vehicle of claim 12, wherein the retention apparatus further comprises a spring, wherein the spring is operably connected to the cap to bias the cap towards the head portion.

16. The grounds maintenance vehicle of claim 12, wherein the cap is biased to move towards the head portion along an axis defined by the shank.

17. The grounds maintenance vehicle of claim 12, wherein the cap defines an opening through which the shank is positioned, wherein the opening of the cap is configured to deny passage of the head portion.

18. The grounds maintenance vehicle of claim 12, wherein the cover comprises one of a slot and a tab and the frame comprises the other of the slot and the tab, wherein the slot is configured to receive the tab to restrict movement of the cover in at least two orthogonal dimensions.

19. The grounds maintenance vehicle of claim 12, wherein the cover extends between a first end region proximate the front end of the frame and a second end region rearward of the first end region, wherein the keyhole opening is located proximate the first end region of the cover.

20. A lawnmower comprising:
a frame carrying a prime mover and extending along a longitudinal axis between a front end and a rear end;
ground engaging members operatively attached to the frame, wherein at least one of the ground engaging members is powered by the prime mover to propel the frame over a ground surface;
an implement attached to the frame;
a cover positioned over at least a portion of the implement, wherein the cover defines an inner surface, an outer surface opposite the inner surface, and a keyhole opening, wherein the keyhole opening defines a head opening and a slot opening extending from the head opening; and
a retention apparatus operably coupled to the frame and corresponding to the keyhole opening, wherein the retention apparatus comprises:
an elongated member comprising a head portion and a shank extending from the head portion, wherein the head opening of the keyhole opening is configured to permit passage of the head portion therethrough and the slot opening of the keyhole opening is configured to deny passage of the head portion;
a cap defining an opening through which the shank of the elongated member is positioned such that the cap is configured to move relative to the elongated member along the shank, wherein the head opening of the keyhole opening is configured to deny passage of the cap and the slot opening of the keyhole opening is configured to deny passage of the cap; and
a spring operably connected to the cap to bias the cap towards the head portion;
wherein the retention apparatus extends through the keyhole opening such that the cap is configured to apply force to the inner surface of the cover proximate the slot opening and the head portion is configured to apply force to the outer surface of the cover proximate the slot opening to restrict movement of the cover relative to the frame.
